(19) United States
(12) Patent Application Publication
(10) Pub. No.: US 2020/0223658 A1
(43) Pub. Date: Jul. 16, 2020

(54) ELEVATOR SYSTEM

(71) Applicants: thyssenkrupp Elevator AG, Essen (DE); thyssenkrupp AG, Essen (DE)

(72) Inventors: Daniel BAUER, Durlangen (DE); Matthias GLÜCK, Hochdorf (DE); Ruslan BONDARENKO, Weilheim an der Teck (DE); Boris ROHDE, Ottersberg/Quelkhorn (DE)

(73) Assignees: thyssenkrupp Elevator AG, Essen (DE); thyssenkrupp AG, Essen (DE)

(21) Appl. No.: 16/348,331

(22) PCT Filed: Nov. 16, 2017
(86) PCT No.: PCT/EP2017/079456

§ 371 Date: May 8, 2019

(30) Foreign Application Priority Data
Nov. 23, 2016 (DE) 10 2016 223 147.2

(51) Int. Cl. B66B 1/34; B66B 9/00; B66B 11/04; H01Q 1/00

(52) U.S. Cl. CPC B66B 1/3461; H01Q 1/007; B66B 11/0407; B66B 9/003

(57) ABSTRACT

An elevator system includes at least one guide rail and at least one elevator cabin movable in a direction of travel along the guide rail. A cabin control unit is installed on the elevator cabin and a central control unit is connected to the cabin control unit by a wireless communications system. The wireless communications system includes a slotted waveguide conductor arrangement installed in the elevator shaft.

### TECHNICAL SCOPE

The invention relates to an elevator system.

### TECHNICAL BACKGROUND

DE 10 2014 220 966 A1 discloses an elevator system in which multiple elevator cabins are operated cyclically in a recirculation mode, similar to a paternoster elevator. In contrast to the classic paternoster elevator, each cabin is driven independently from the other cabins and is consequently able to stop at any arbitrary stop independently of the other cabins. Transfer devices are provided in order to transfer the cabins from a vertical direction of travel into a horizontal direction of travel in order to be able to move the cabins in this way between different elevator shafts. The elevator cabins are thus movable in a plane which is spanned by the two elevator shafts and the cross shafts which connect them. In the case of such an elevator system, a data connection between the elevator cabins and a central elevator control cannot be realized with a traveling cable as at present. A possibility for the data connection consists in wireless transmission platforms. However, high demands on safety, reliability and speed must be imposed here.

In particular, safety-relevant data signals relating to speed or an instruction for emergency braking require a reliably quick data transmission. In this case, it has been shown that on account of reinforced concrete parts, metal cabins and metal rails, transmission paths in an elevator shaft are not able to be maintained with sufficient reliability via simple WLAN hotspots.

A further desirable requirement is to be able to use license-free frequency bands, at the same time, however, interference factors from the surrounding area on account of other use of said frequency bands are to be avoided.

### DISCLOSURE OF THE INVENTION

It is the object of the present invention to provide a suitable data connection between the cabins and an elevator control unit for an elevator system of the type described above. The object underlying the invention is achieved by an elevator system as claimed in claim 1; preferred designs are produced from the subclaims and the description.

The elevator system includes at least one guide rail, at least one elevator cabin, in particular a plurality of elevator cabins, which is movable in a direction of travel along the guide rail, a cabin control unit which is installed on the elevator cabin and a central control unit which is connected to the cabin control unit by means of at least one wireless communications system. The at least one wireless communications system includes a slotted waveguide conductor arrangement which is installed in the elevator shaft.

Such a slotted waveguide conductor arrangement includes, in particular, at least one slotted waveguide and at least one cabin antenna. The slotted waveguide comprises, in particular, a cavity, which extends in the direction of travel, for guiding electromagnetic waves, wherein the cavity is delimited by side walls which are arranged parallel to the direction of travel. The cabin antenna is installed on an elevator cabin, which means essentially that the cabin antennae move in the shaft with the elevator cabin. The slotted waveguide comprises a passage opening, in particular a slot, which extends parallel to the direction of travel, for receiving the cabin antenna in part. When the cabin is moved, the passage opening, as a result of its extension parallel to the direction of travel, makes it possible for the cabin antenna to be able to project into the cavity in spite of the movement of the cabin in the shaft. Such slotted waveguides are described in principle in DE 35 05 469 A1.

The advantage of using slotted waveguides lies in the reliability of the data transmission on account of the very low susceptibility to failure. With the cavity thereof, the slotted waveguide provides a defined dispersion region for the electromagnetic waves; said dispersion region is delimited by the side wall such that the electromagnetic waves simply do not leave the cavity or only leave it negligibly. Equally, electromagnetic (interference) waves within the relevant spectrum are hardly able to enter into the cavity and cause disturbances. The mobility of the cabin antennae is nevertheless ensured by the through passage. As a result of the combination of the spatial delimitation and shielding with at the same time full support of the mobility of the cabin antennae, the use of the slotted waveguide arrangement provides the optimum data transmission concept for the generic elevator system.

The central control unit is preferably connected to the cabin control unit by means of at least two wireless communications systems, wherein the two wireless communications systems are realized separately from one another. A redundancy is produced as a result of the use of two wireless communications systems.

The separation of the communications systems, in this case, can be realized by a spatial separation. In the case of a spatial separation, the cabin antenna, the shaft antenna and the spatial position of the air interface for the two communications systems are realized spaced apart spatially from one another. The position of the air interface is defined by the position of the cavity in the case of slotted waveguides.

As an alternative to this, the separation of the communications systems can be realized by using frequencies that differ from one another. In this connection, the air interface of the two communications systems can extend through the same slotted waveguide; the two communications systems, in this case, use different frequencies for the data transmission. In this case, in particular each communications system can also comprise separate cabin antennae and/or separate shaft antennae which are, however, used in the same cavity. In particular, each cabin antenna, in this case, has associated therewith a cabin-side transmit/receive controller which is individual to the communications system and in particular each shaft antenna, in this case, has associated therewith a shaft-side transmit/receive controller which is individual to the communications system.

Each communications system preferably comprises at least one shaft antenna, which is installed in the slotted waveguide, and two cabin antennae, which are installed on the cabin and project into the associated slotted waveguide, wherein the two cabin antennae of a communications system are arranged one after the other when viewed in the direction of travel. As a result of the arrangement of the cabin antennae one after the other in the direction of travel, it is possible to avoid the cabin antennae simultaneously moving into a dead spot. Such dead spots can be produced at the transitions between two slotted waveguides which are arranged one behind the other. Such transitions can certainly be avoided in the case of conventional elevator systems where the cabins simply travel in one direction; in the case of elevator systems where the cabins change the direction of travel, it is possible to provide a rotatable slotted waveguide which rotates synchronously with a rotatable rail segment. A transition is inevitably present between a rotatable slotted waveguide and a fixed slotted waveguide. In principle, a shaft antenna can be realized in one piece with at least one wall portion of a slotted waveguide.

When viewed in the direction of travel, the two cabin antennae of a first communications system are preferably arranged in such a manner with respect to the two cabin antennae of the second communications system that transitions between two slotted waveguides, which are arranged one behind the other in the direction of travel, are reached in each case by the four cabin antennae at various points in time. A high level of failure safety of the data transmission can be generated hereby, which is explained in more detail by way of the exemplary embodiment.

The invention is applicable, in particular, in the case of such an elevator system which includes:

at least one first guide rail which is oriented in a first, in particular vertical, direction,

at least one second guide rail which is oriented in a second, in particular horizontal, direction,

at least one shaft, in relation to which at least one of the guide rails is fixedly retained;

at least one rail segment which is rotatable in relation to the shaft and is transferable between an orientation in the first direction and an orientation in the second direction,

at least one elevator cabin which is movable along the guide rails by means of a chassis and which is transferable between the various guide rails via the rotatable rail segment.

Transitions, at which the quality or reliability of the wireless communications system can be reduced, are formed in particular at an interface between the guide rails and the rotatable rail segment. The reliability of the data transmission between the central control unit and the cabin control unit is able to be improved as a result of the present invention. In particular, in the case of such an elevator system, the elevator cabin is guided on the guide rails mounted in a rucksack-type manner and/or is driven in a ropeless manner.

WLAN as based on IEEE 802.11 in particular within the frequency range of 2.4 GHz, 5 GHz and/or 60 GHz is preferable for wireless data transmission in the slotted waveguide.

In a further development the side wall of the slotted waveguide can be integrated in a guide rail for guiding the elevator cabin.

### BRIEF DESCRIPTION OF THE DRAWING

The invention is explained in more detail below by way of the figures, each of which is as follows

FIG. 1 shows a schematic representation in perspective of a section of an elevator system according to the invention;

FIG. 2 shows a schematic representation in perspective of parts of the data-transmitting elements of the elevator system according to FIG. 1;

FIG. 3 shows a schematic representation in top view of details of the data transmission structure of the elevator system according to FIG. 1 in a first design;

FIG. 4 shows a schematic representation of a functional block representation of the data-transmitting elements of the elevator system according to FIG. 1;

FIG. 5 shows a schematic representation of a movement diagram of the antennae of the elevator system according to FIG. 1 in a first configuration;

FIG. 6 shows a schematic representation of a movement diagram of the antennae of the elevator system according to FIG. 1 in a second configuration;

FIG. 7 shows a schematic representation in top view of details of the data transmission structure of the elevator system according to FIG. 1 in a second design;

FIG. 8 shows a schematic representation in top view of details of the data transmission structure of the elevator system according to FIG. 1 in a third design;

FIG. 9 shows a schematic representation in top view of details of the data transmission structure of the elevator system according to FIG. 1 in a fourth design.

### DESCRIPTION OF EMBODIMENTS

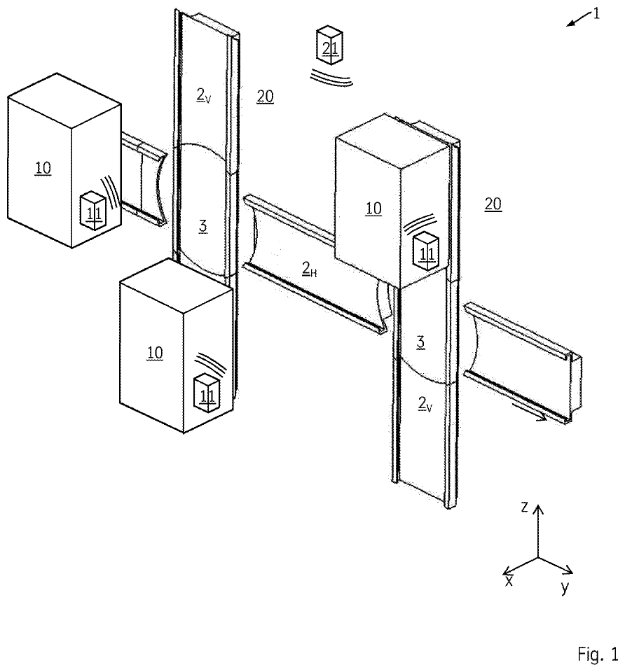

FIG. 1 shows parts of an elevator system 1 according to the invention. The elevator system 1 includes a plurality of guide rails 2, along which multiple elevator cabins 10 can be guided by way of a rucksack-type bearing arrangement. A guide rail 2_{V} is oriented vertically in a first direction and makes it possible for the guided elevator cabin 10 to be movable between various floors. Multiple guide rails are arranged in adjacent shafts 20 in said vertical direction.

A horizontal guide rail 2_{H}, along which the elevator cabin 10 is able to be guided by way of a rucksack-type bearing arrangement, is arranged between the two vertical guide rails 2_{V}. Said horizontal guide rail 2_{H} is oriented horizontally in a second direction and makes it possible for the elevator cabin 10 to be able to be moved within a floor. In addition, the horizontal guide rail 2_{H} connects the two vertical guide rails 2_{V} together. Consequently, the second guide rail 2_{H} also serves for switching the elevator cabin 10 between the two vertical guide rails in order to carry out, for example, a modern paternoster operation.

The elevator cabin 10 is able to be switched from one guide rail to the other guide rail via in each case a rotatable rail segment 3. All the rails 2, 3 are installed at least indirectly in a shaft wall 20. Such elevator systems are described accordingly in WO 2015/144781 A1 and in German patent applications 10 2016 211 997.4 and 10 2015 218 025.5.

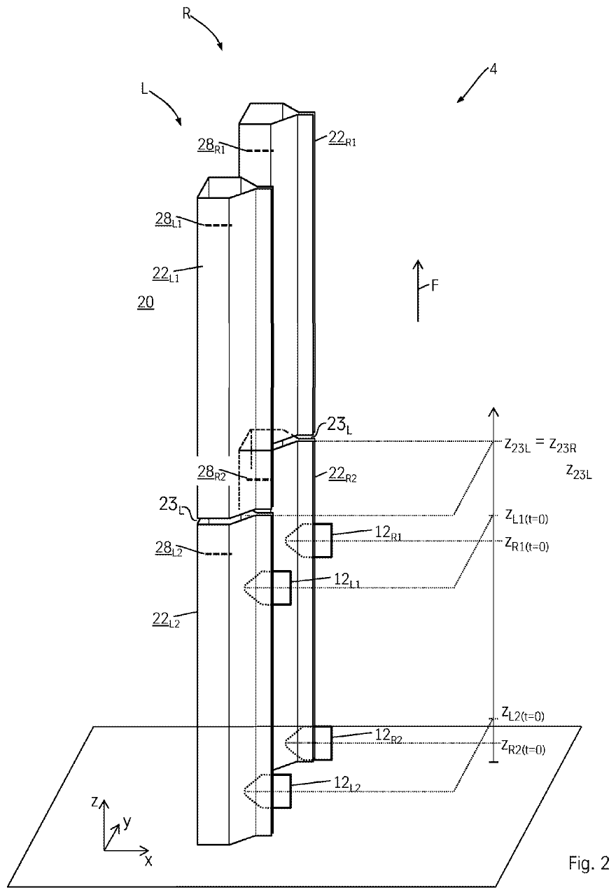

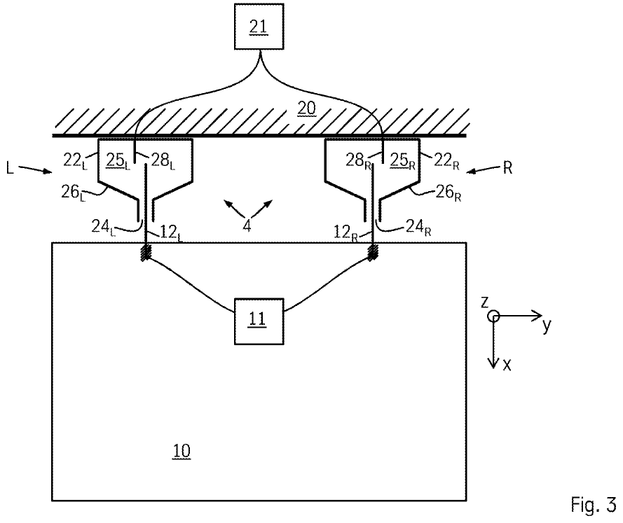

Cabin control units 11, which move along the rails 2 with the cabins, are installed on each of the cabins 10. Said cabin control units 11 are in data contact with a central control unit 21 of the elevator system 1. As no traveling cables can be used in the case of such elevator systems, the data transmission has to be realized in another manner. Sliding contacts have proved to be susceptible to wear such that wireless data transmission is used between the cabin control units 11 and the central control unit 21. A possibility for wireless data transmission is described in more detail below by way of FIGS. 2 to 4.

Data is transmitted wirelessly by way of a slotted waveguide arrangement 4. Said slotted waveguide arrangement 4 includes two separate communications systems L, R, which are able to carry out wireless data transmission independently of one another and are consequently redundant. As the designs of the two communications systems L, R are substantially identical, only the first communication system L is described below; insofar as nothing to the contrary is specified, the description also relates to the second communications system R. The second communications system R, when viewed in the direction of travel F, is arranged parallel to the first communications system L.

The first communications system L includes a plurality of slotted waveguides 22_{L1}, 22_{L2}, which are arranged one behind the other in the direction of travel F. Two slotted waveguides 22_{L1}, 22_{L2}, per communications system L, R, are shown representatively for this in the figures. The slotted waveguides 22_{L1}, 22_{L2}, are realized identically such that one slotted waveguide 22 is described below representing all further slotted waveguides and the indices L, R are omitted. The slotted waveguide 22 is installed fixedly on the shaft wall 20 and includes multiple walls 26 which extend parallel to the direction of travel F. A cavity 25, which extends parallel to the direction of travel F, is formed by the walls 26. The slotted waveguide 22 includes a shaft antenna 28, which is set up to couple electromagnetic radiation into the cavity 25 or to receive it from the cavity 25. The shaft antenna 28 is connected in a wire-bound manner to a central control unit 21. The electromagnetic radiation is the carrier medium for the wireless data transmission. The wall 26 is formed from a shielding material. For the design of the slotted waveguide 22 and the selection of suitable wavelengths, reference can be made to the relevant literature concerning slotted waveguides as waveguides for electromagnetic waves.

The electromagnetic waves are essentially able to disperse well in the cavity 25, whilst the electromagnetic waves hardly penetrate the wall 26. Consequently, the slotted waveguides 22 are also suitable for an extremely secure, wireless data transmission, as the signals transmitted in the cavity 25 are secured against unauthorized interception and a manipulation of the signals from outside of the slotted waveguide 22 is made difficult. The cross section of the slotted waveguide, in this case, is not limited to the cross section shown in the figures, on the contrary a plurality of angular or round cross sections is conceivable.

The walls 26 realize a slot 24 which extends parallel to the direction of travel F, through which cabin antennae 12 are introduced in part into the cavity 25. Each of the cabin antennae 12 is installed on the elevator cabin 10 and consequently in operation moves with the elevator cabin 10 in the direction of travel F. The orientation of the slot 24 parallel to the direction of travel F makes it possible for the cabin antennae 12 to always project into the cavity 25. The cabin antennae 12 are set up to couple electromagnetic radiation into the cavity 25 or to receive it from the cavity 25 and consequently are in communications contact with the associated shaft antenna 28. The cabin antennae 12 are connected in a wire-bound manner to a cabin control unit 11 which is installed on the elevator cabin 10.

The communications contact between an individual shaft antenna 28_{L1}, 28_{L2}, 28_{R1}, 28_{R2} and an individual cabin antenna 12_{L1}, 12_{L2}, 12_{R1}, 12_{R2} can, however, only be maintained sufficiently when the respective cabin antenna 12 projects into the slotted waveguide 22_{L} or 22_{R} to which the respective shaft antenna 28_{L} or 28_{R} is assigned.

In the case of the generic elevator systems 1, a slotted waveguide 22 does not inevitably extend over the entire height of the elevator shaft. A transition between two consecutive slotted waveguides 22_{L1}, 22_{L2} or 22_{R1}, 22_{R2}, in particular in the interface region between a fixed guide rail 2 and a rotatable rail segment 3, is unavoidable, for an associated slotted waveguide is held so as to be rotatable as it were at the rotatable rail segment in order to be rotated with the rotatable rail segment. The communications contact between an individual cabin antenna and the shaft antenna 28 is inevitably ruptured at a transition 23_{L} or 23_{R} between two slotted waveguides 22_{L1} and 22_{L2} or 22_{R1} and 22_{R2}.

In the example in FIG. 2, when traveling in the direction of travel F the cabin antenna 12_{L1} reaches a transition 23 as first of the cabin antennae. So that via the first communications system L there is communications contact at all times between a shaft antenna 28_{L1}, 28_{L2} of the first communications system L and a cabin antenna 12_{L1}, 12_{L2}, the communications system L comprises two cabin antennae 12_{L1}, 12_{L2} per elevator cabin 10. The cabin antennae 12_{L1}, 12_{L2} of the first communications system L are arranged in such a manner that in each case at least one cabin antenna is not arranged at a transition 23. When, therefore, the first cabin antenna 11_{L1} reaches the transition 23_{L}, the second cabin antenna 11_{L2} is arranged sufficiently distant from the transition 23_{L} and is in secure communications contact with the shaft antenna 28_{L2}. Consequently, one seamless (in the temporal sense), wireless data connection per communications system L is always able to be maintained.

The two cabin antennae 12_{L1}, 12_{L2} consequently operate redundantly inside the communications system L in order to compensate for the inevitable break in communications contact at the transition 23_{L}. However, said redundancy always comes into play when one of the antennae passes the transition. At said moment, however, there is no longer any redundancy available in order to compensate for failure of the active antenna. As the second antenna is consequently used inside a communications system for the purpose of compensating for a failure of an antenna which occurs inevitably as part of the operation, the provision of the second antenna per communications system does not provide any viable redundancy. The second communications system R now serves for this purpose.

The second communications system R operates, in principle, exactly as described previously for the first communications system L. The use of said two communications systems L, R consequently generates a redundancy of two seamlessly functioning communications systems L, R. The operation of the associated elevator cabin 10 can be ensured when one of the two communications systems L, R already functions properly.

For comparison: in the present case of application there is no sufficiently reliable option provided for realizing the bridging of the loss of communications contact simply as a result of switching to the second communications system R when the antenna of the first communications system L travels over the transition 23. Said solution is certainly possible technically but would simply provide seamlessness at the expense of the redundancy. The second communications system R, in this connection, would inevitably have to engage in order to maintain a seamless data transmission. Seamlessness would no longer be ensured should there be a fault in one of the two communications systems L, R. There is, consequently, a lack of redundancy.

In order, consequently, to produce a seamless and redundant wireless data connection, two communications systems L, R, which each include per elevator cabin 10 two cabin antennae 12 which are arranged offset in the direction of travel F, are provided according to the invention. Naturally the distance between the cabin antennae must not be equal to the distance between two transitions.

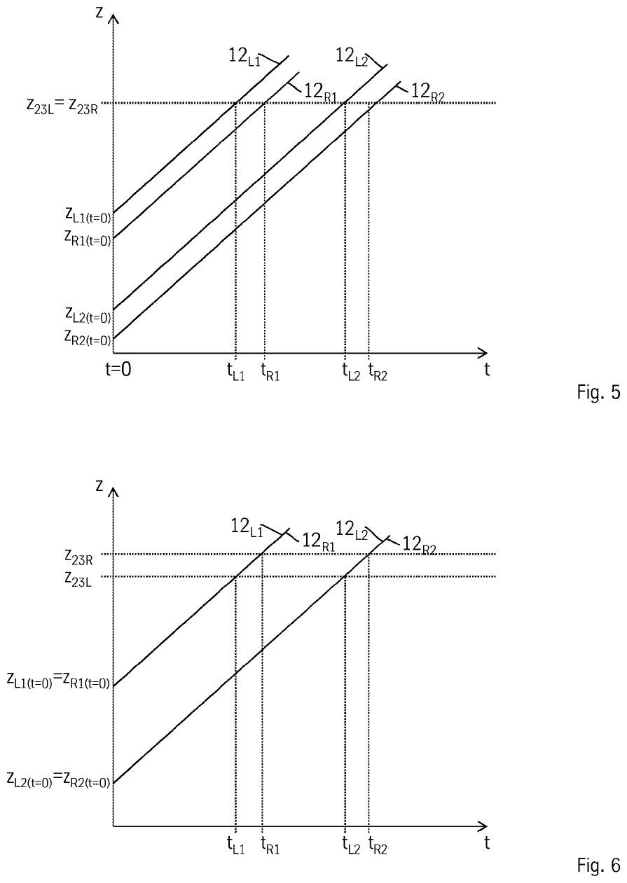

A preferred spatial arrangement of the cabin antennae 12 is described by way of FIG. 5, with reference to FIG. 2. FIG. 5 provides a space and time diagram of the cabin antennae 12. A space and time line is recorded for each cabin antenna 12. This begins with t=0 at a starting z position which is fixed for each cabin antenna 12 z_{L1}(t=0), z_{R1}(t=0), z_{L2}(t=0), z_{R2}(t=0) and can also be seen in FIG. 2. When viewed from above, the order of the cabin antennae 12 is as follows:

1. First cabin antenna 12_{L1} of the first communications system L;

2. First cabin antenna 12_{R1} of the second communications system R;

3. Second cabin antenna 12_{L2} of the first communications system L;

4. Second cabin antenna 12_{R2} of the second communications system R;

where z_{L1}(t=0)>z_{R1}(t=0)>z_{L2}(t=0), z_{R2}(t=0).

The transitions 23_{L}, 23_{R} are at the same z position on both communications systems L, R.

Correspondingly, the antennae each reach a transition at the following points in time:

1. First cabin antenna 12_{L1} of the first communications system L at time t_{L1};

2. First cabin antenna 12_{R1} of the second communications system Rat time t_{R1};

3. Second cabin antenna 12_{L2} of the first communications system L at time t_{L2};

4. Second cabin antenna 12_{R2} of the second communications system R at time t_{R2};

where t_{L1}<t_{R1}<t_{L2}<t_{R2}.

It is advantageous, in this case, for the cabin antennae 12_{L1}, 12_{L2} of the first communications system L and the cabin antennae 12_{R1}, 12_{R2} of the second communications system R to always reach the respective transition 23_{L}, 23_{R} at different points in time. The failure safety is once again significantly increased in this way. For in spite of the use of two cabin antennae 12 per communications system L, R, when traveling over a transition the risk of an at least short-term failure of the data transmission is not to be regarded as negligible. It would be a problem if such a short-term failure of the data transmission were to occur in both communications systems L, R at the same time. As the antennae of both communications systems now never reach a transition at the same time, the risk of simultaneous failure is once again significantly reduced to a risk that is now negligible.

Said advantage can also be realized as a result of the z position of the transitions differing from one another, as is shown by way of the diagram in FIG. 6. As an example, the cabin antennae are arranged in such a manner on the elevator cabin 10 that the starting z position realizes the following characteristic:

z_{L1}(t=0)=z_{R1}(t=0)>z_{L2}(t=0)=z_{R2}(t=0).

The two first cabin antennae 22_{L1}, 22_{R1} of both communications systems L, R are consequently arranged at identical height. The two second cabin antennae 22_{L2}, 22_{R2} of both communication systems L, R are consequently also arranged at identical height. In order, nevertheless, to reach the respective transitions at different points in time, the transitions 23_{L}, 23_{R} are arranged at different z positions z_{23L}, z_{23R}.

Also in the case of said variant, the cabin antennae 12 reach the respective transitions 23_{L}, 23_{R} at the times t_{L1}<t_{R1}<t_{L2}<t_{R2}.

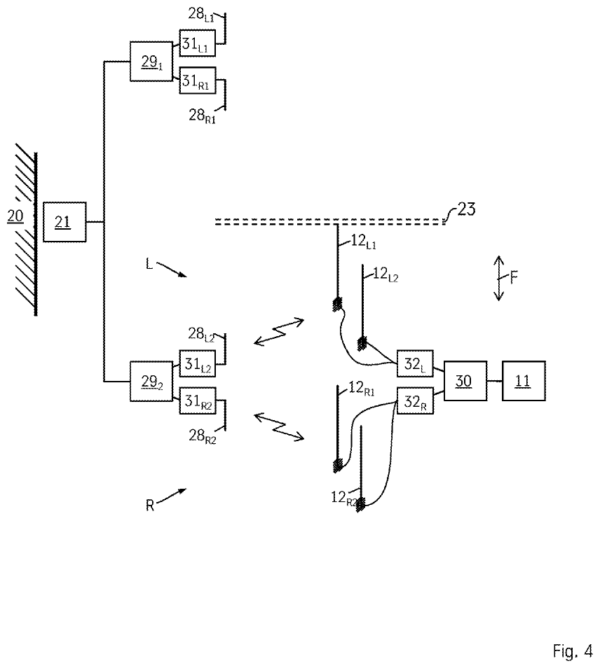

FIG. 4 shows a block diagram of the wireless data transmission. Data is to be transmitted from the central control unit 21, which is installed fixedly in relation to the shaft 20, to the cabin control unit 11 and vice versa. A slotted waveguide, in this case, has associated therewith a shaft-side data doubler 29₂ which forwards the data to the two communications systems L, R.

The first communications system L comprises a shaft-side transmit/receive controller 31_{L2} which is connected to the shaft antenna 28_{L2}. Said shaft antenna 28_{L2} radiates the signal wirelessly to the two cabin antennae 12_{L1}, 12_{L2} which are associated with the first communications system L and which forward the received signals to a cabin-side transmit/receive controller 32_{L} of the first communications system R. The received data is transmitted from the transmit/receive controller 32_{L} to a cabin-side data doubler 30.

The second communications system R comprises a shaft-side transmit/receive controller 31_{R2} which is connected to the shaft antenna 28_{R2}. Said shaft antenna 28_{L2} radiates the signal wirelessly to the two cabin antennae 12_{R1}, 12_{R2} which are associated with the second communications system L and which forward the received signals to a cabin-side transmit/receive controller 32_{R} of the second communications system R. The received data is transmitted from the transmit/receive controller 32_{R} to the cabin-side data doubler 30.

In the normal case, the cabin-side data doubler 30 receives the same data from both transmit/receive controllers 32_{L}, 32_{R} and forwards it once to the cabin control unit 11. Should there be a fault in the communications transmission on one of the communications systems, the cabin-side data doubler 30 receives the data to be transmitted only once. In this case too, the cabin-side data doubler 30 forwards the received data to the cabin control unit 11, which consequently remains unaffected by the communications fault.

The above description is to be applied analogously to the reverse transmission of data from the cabin control unit 11 to the central control unit 21, the functions
of the cabin-side data doubler 30 then being exchanged with those of the shaft-side data doubler 29,
of the cabin-side transmit/receive controller 32 then being exchanged with those of the shaft-side transmit/receive controller 31,
of the cabin antennae 12 then being exchanged with those of the shaft antennae 28.

The redundant realization provides, in particular, that in each case separate shaft-side transmit/receive controllers 31 and cabin-side transmit/receive controllers 32 are provided per communications system L, R and in each case separate shaft-side transmit/receive controllers 31 and cabin-side transmit/receive controllers 32 are provided per communications system L, R.

A separate slotted waveguide 22 is not absolutely necessary, as is explained again by way of FIG. 9.

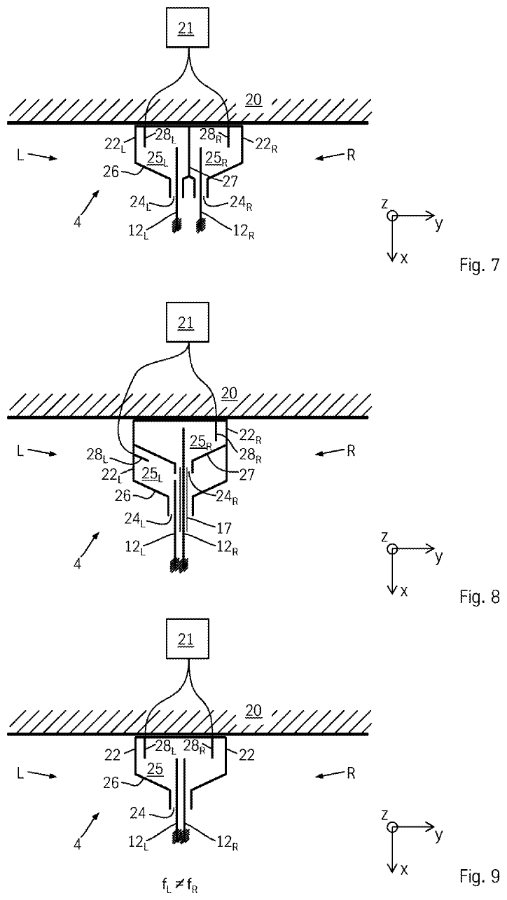

FIGS. 7 to 9 show variants of the communications systems L, R shown beforehand, to which the above description continues to be applicable; the following description demonstrates the essential differences.

The two slotted waveguides 22_{L}, 22_{R} are always arranged together in a common housing in the variants in FIGS. 7 to 9.

A partition wall 27, which separates the two cavities 25_{L}, 25_{R} from one another, is provided in the variant according to FIG. 7. The partition wall 27 extends substantially parallel to the direction of travel F and largely parallel to the orientation of the cabin antennae 12_{L}, 12_{R}. The partition wall 27 is formed from a shielding material so that the electromagnetic waves largely do not leave the respective cavities 25. Each slotted waveguide 22_{L}, 22_{R} comprises, in this case, a separate slot 12_{L}, 12_{R}, through which protrude in each case either only the cabin antennae 22_{L} of the first communications system L or (exclusive “or”) only the cabin antennae 12_{R} of the second communications system R.

Even when both communications systems L, R utilize common elements 26, 27 in part in said design, the communications systems L, R are separated by the partition wall 27 between the cavities 25_{L}, 25_{R} and by the use of separate shaft antennae 28 and cabin antennae 12.

A partition wall 27, which separates the two cavities 25_{L}, 25_{R} from one another, is provided in the variant according to FIG. 8. The partition wall 27 extends substantially parallel to the direction of travel F and largely transversely to the orientation of the cabin antennae 12_{L}, 12_{R}. The partition wall 27 is formed from a shielding material so that the electromagnetic waves largely do not leave the respective cavities 25.

A first slot 24_{L} is arranged, in this case, in the housing wall and connects the surrounding area to the first cavity 25_{L}. A second slot 24_{R} is arranged, in this case, in the partition wall 27 and connects the first cavity 25_{L} to the second cavity 25_{R}. The cabin antenna 12_{L} of the first communications system L projects, in this case, through the first slot 24_{L} into the first cavity 25_{L}.

The cabin antenna 12_{R} of the second communications system R also projects through the first slot 24_{L} into the first cavity 25_{L} but extends further through the second slot 24_{R} into the second cavity 25_{R}. So that no interactions occur between the cabin antenna 12_{R} of the second communications system R and the electromagnetic waves in the cavity 25_{L} of the first communications system L, the cabin antenna 12_{R} of the second communications system R comprises a shielding 17 in the region of the cavity 25_{R} of the second communications system R, similar to a shielding in the case of a coaxial cable.

Even when both communications systems utilize common elements 26, 27, 24_{L} in part in this design, the communications systems L, R are separated by the partition wall 27 between the cavities 25_{L}, 25_{R}, the use of separate shaft antennae 28 and cabin antenna 12 and the shielding 17 of such cabin antennae 12_{R} wherever they are arranged in the region of the cavity 25_{L} of a slotted waveguide 25_{L} of the respective other communications system L.

The variant according to FIG. 9 does not provide a partition wall which separates two cavities from one another. Rather, the two communications systems L, R divide one common cavity 25. The cabin antennae 12_{L}, 12_{R} of the two communications systems L, R project through a common slot 24 into said common cavity 25 and there interact in an intended manner with the electromagnetic waves that are there. The shaft antennae 28_{L}, 28_{R} of the two communications systems L, R are also received in said common cavity 25.

Even when both communications systems utilize common elements 22, 25, 26 in part in this design, the communications systems L, R are separated by the use of separate shaft antennae 28 and cabin antennae 12. The shaft and cabin antennae 28_{L}, 12_{L} of the first communications system L utilize, in this case, a different frequency band to the shaft and cabin antennae 28_{R}, 12_{R} of the second communications system R. As, in this connection, simply mechanical elements are used in common by both communications systems L, R and said elements have a very high level of failure safety on account of their robustness, the reliability demanded of the redundancy is met.

In FIGS. 8 and 9 the cabin antennae 12_{L}, 12_{R} of both communications systems L, R project through the common slot 24_{L} or 24. To improve the representation in said view, the cabin antennae 12_{L}, 12_{R} are shown side by side here. As an alternative to such an arrangement, it is also possible for the antennae of the different communications systems L, R also to be arranged precisely one behind the other in the direction of travel F. The slot 24_{L}, 24 can thus be realized in a narrower manner (that is to say smaller in the y direction), which, in particular, reduces the dissipation of electromagnetic energy at the slot 24_{L}, 24.

In a further development which is not shown the elevator system includes a further, third slotted waveguide arrangement. Said third slotted waveguide arrangement includes a third slotted waveguide and at least one antenna which is fastened to the elevator cabin. Said third slotted waveguide arrangement is used for the transmission of data which is less safety relevant. For example, this is data for the operation of an entertainment system. Such data allows for temporary buffering and consequently copes, in principle, with an interruption in the data transmission of a few seconds. In this respect, one slotted waveguide and one cabin antenna can suffice for this.

### LIST OF REFERENCES

1 Elevator system

2 Guide rail

3 Rotatable rail segment

4 Slotted waveguide arrangement

10 Elevator cabin

11 Cabin control unit

12 Cabin antenna

17 Shielding

20 Shaft

21 Central control unit

22 Slotted waveguide

23 Transition

24 Slot

25 Cavity

26 Side wall

27 Partition wall

28 Shaft antenna

29 Shaft-side data doubler

30 Cabin-side data doubler

31 Shaft-side transmit/receive controller

32 Cabin-side transmit/receive controller

F Direction of travel

L, R Separate communications system

1.-8. (canceled)

9. An elevator system, comprising:
a guide rail,
an elevator cabin which is configured to move in a direction of travel along the guide rail,
a cabin control unit disposed on the elevator cabin, and
a central control unit in communication with the cabin control unit by a wireless communications system,
wherein the wireless communications system includes a slotted waveguide conductor arrangement installed in the elevator shaft.

10. The elevator system of claim 9, including a plurality of guide rails and a plurality of elevator cabins, each of the elevator cabins to move along one or more of the plurality of guide rails.

11. The elevator system of claim 9, wherein the slotted waveguide conductor arrangement includes a slotted waveguide and a cabin antenna,
wherein the slotted waveguide comprises a cavity, which extends in the direction of travel, configured to guide electromagnetic waves, wherein the cavity is delimited by side walls that are arranged parallel to the direction of travel,
wherein the cabin antenna is installed on the elevator cabin, and
wherein the slotted waveguide comprises a passage opening, which extends parallel to the direction of travel, the passage opening configured to receive at least part of the cabin antenna.

12. The elevator system of claim 9, wherein the central control unit is connected to the cabin control unit by at least two wireless communications systems, wherein the two wireless communications systems are separate from one another.

13. The elevator system of claim 12, wherein the communications systems each use an air interface and the air interfaces for each communications system are separated from one another spatially and/or are separated from one another by the use of frequencies which differ from one another.

14. The elevator system of claim 12, wherein each of the communications systems comprise at least one shaft antenna, which is installed in the slotted waveguide, and two cabin antennae, which are installed on the cabin and project into said slotted waveguide, wherein the two cabin antennae of each of the communications systems are arranged one after the other when viewed in the direction of travel.

15. The elevator system as claimed in claim 12, wherein, when viewed in the direction of travel, the two cabin antennae of a first of the communications systems are arranged in such a manner with respect to the two cabin antennae of a second of the communications systems that transitions between two slotted waveguides, which are arranged one behind the other in the direction of travel, are reached in each case by the four cabin antennae at various points in time.

16. The elevator system of claim 9, comprising:
at least one first guide rail which is oriented in a first direction,
at least one second guide rail which is oriented in a second direction, the first direction and the second direction having different orientations, and
at least one rail segment which is rotatable in relation to the shaft and is transferable between an orientation in the first direction and an orientation in the second direction.

17. The elevator system of claim 16, wherein the first direction is vertical, and the second direction is horizontal.

18. The elevator system of the claim 9, wherein the elevator cabin is guided on the guide rail mounted in a rucksack-type manner and/or is driven in a ropeless manner.
